(19) United States
(12) Patent Application Publication
(10) Pub. No.: US 2004/0055412 A1
(43) Pub. Date: Mar. 25, 2004

(54) Crank set having a pedal pivoted to a crank arm through an adapter

(76) Inventor: Chung-I Chen, Taichung Hsien (TW)

Correspondence Address: LADAS & PARRY, 224 SOUTH MICHIGAN AVENUE, SUITE 1200, CHICAGO, IL, 60604, US

(21) Appl. No.: 10/252,261

(22) Filed: Sep. 23, 2002

(51) Int. Cl. G05G 1/14

(52) U.S. Cl. 74/594.1

(57) ABSTRACT

A bicycle crank set includes a crank arm having a pedal-connecting end formed with an internally threaded hole, and a tubular adapter having an externally threaded portion inserted threadedly into the internally threaded hole in the pedal-connecting end of the crank arm. A pedal unit is disposed at one side of the crank arm, and includes a pedal shaft and a pedal body pivoted to the pedal shaft to permit rotation of the pedal body about the pedal shaft. The pedal shaft has a crank-connecting end that projects outwardly from the pedal body and through a shaft hole in the adapter and that is formed with an internally threaded hole. A headed bolt is disposed at the other side of the crank arm, extends into the shaft hole in the tubular adapter, and threadedly engages the internally threaded hole in the pedal-connecting end of the pedal shaft.

### BACKGROUND OF THE INVENTION

1. Field of the Invention

The present invention relates to a crank set, more particularly to a crank set having a pedal pivoted to a crank arm through an adapter.

2. Description of the Related Art

Referring to FIG. 1, a conventional bicycle crank set is shown to include a pair of crank arms 20 and a pair of pedal units 30. Each crank arm 20 has an axle-mounting end 23 mounted securely on a chain sprocket 25 for co-rotation therewith, and a pedal-connecting end 22 that is formed with an internally threaded hole 21 extending in a transverse direction relative to a longitudinal direction of the crank arm 20. Each pedal unit 30 is disposed at one side of a respective one of the crank arms 20, and includes a pedal shaft 10 and a pedal body 30″ pivoted to the pedal shaft 10 so as to permit rotation of the pedal body 30″ about the pedal shaft 10. The pedal shaft 10 has a threaded portion 11 threadedly inserted into the internally threaded hole 21 in the pedal-connecting end 22 of the crank arm 20.

One disadvantage of the aforesaid conventional crank set resides in that the thread of the threaded portion 11 of the pedal shaft 10 of each pedal unit 30 is required to be directional such that rotation of the crank arms 20 in a forward direction by an external force applied on the pedal units 30 will not result in loosening of the threaded portion 11 with respect to the internally threaded hole 21. For instance, if the threaded portion 11 is turned in the same direction as the forward direction for tightening in the internally threaded hole 21, forward rotation of the crank arms 20 will result in loosening of the threaded portion 11 due to holding of the pedal units 30 by the applied external force. As a consequence, manufacture and assembly of the conventional crank set is relatively inconvenient.

### SUMMARY OF THE INVENTION

Therefore, the object of this invention is to provide a crank set having a pedal connected to a crank arm through an adapter so as to eliminate the aforesaid disadvantage associated with the prior art.

Accordingly, a crank set according to the present invention includes: a crank arm extending in a longitudinal direction, and having two opposite sides and a pedal-connecting end that is formed with an internally threaded hole extending in a transverse direction relative to the longitudinal direction; and a tubular adapter extending in the transverse direction, and having an externally threaded portion inserted threadedly into the internally threaded hole in the pedal-connecting end of the crank arm, and an enlarged head extending axially from the externally threaded portion. The adapter confines a shaft hole extending through the externally threaded portion and the enlarged head. A pedal unit is disposed at one of the opposite sides of the crank arm, and includes a pedal shaft and a pedal body pivoted to the pedal shaft so as to permit rotation of the pedal body about the pedal shaft. The pedal shaft has a crank-connecting end that projects outwardly from the pedal body into the shaft hole in the adapter and that is formed with an internally threaded hole. A headed bolt is disposed at the other one of the opposite sides of the crank arm, extends into the shaft hole in the tubular adapter, and threadedly engages the internally threaded hole in the crank-connecting end of the pedal shaft so as to prevent disengagement of the pedal unit from the crank arm.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is an exploded view of a conventional bicycle crank set shown together with a chain sprocket;

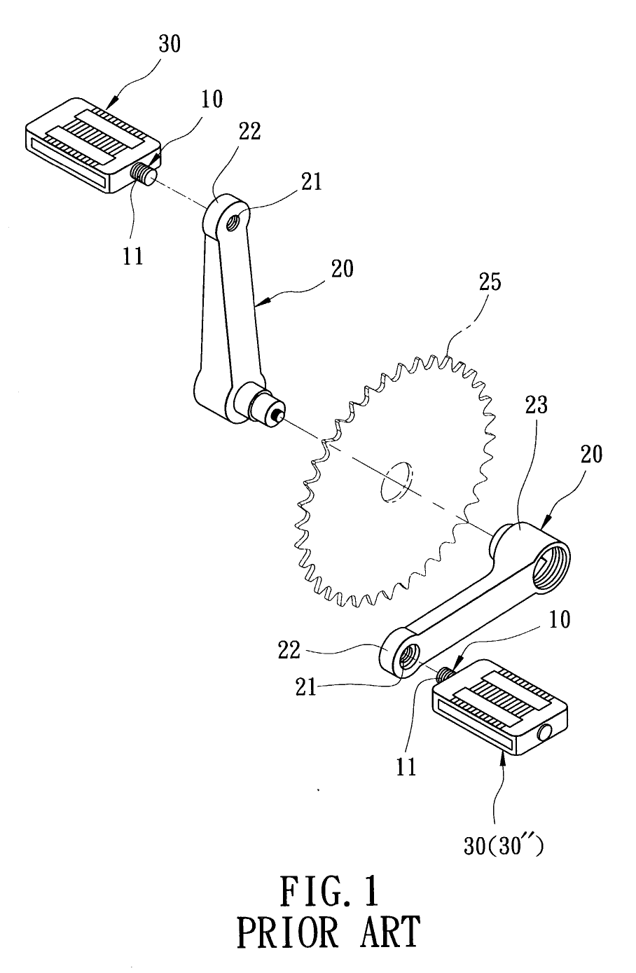

FIG. 2 is an exploded view of the preferred embodiment of a bicycle crank set according to the present invention;

FIG. 3 is an assembled perspective view of the preferred embodiment according to the prevent invention;

FIG. 4 is a sectional view of the preferred embodiment taken along lines IV-IV in FIG. 3; and

FIG. 5 is an exploded view of a modified preferred embodiment of this invention.

### DETAILED DESCRIPTION OF THE PREFERRED EMBODIMENTS

Before the present invention is described in greater detail with reference to the following preferred embodiments, it should be noted that same reference numerals have been used to denote similar elements throughout the specification.

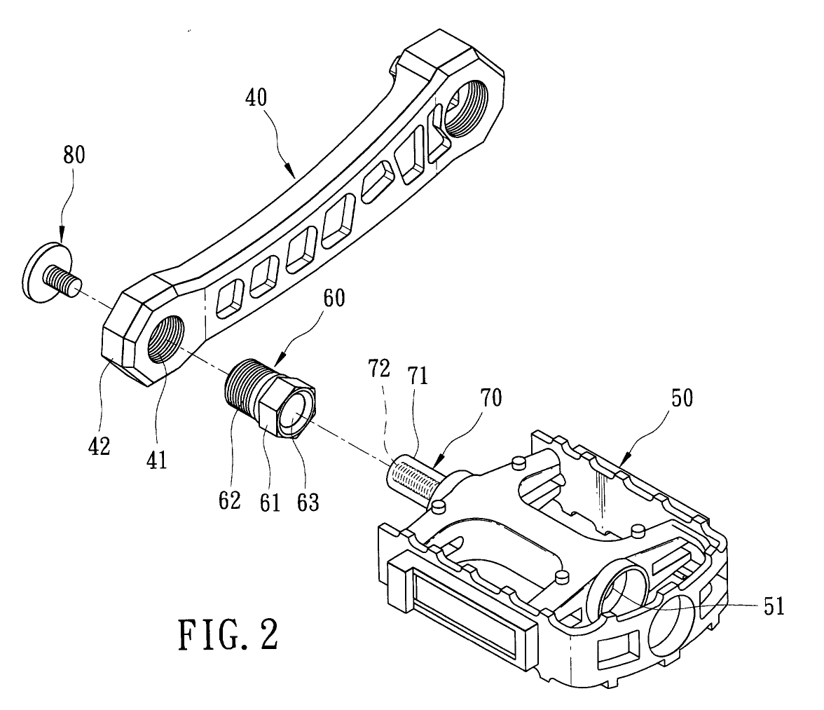

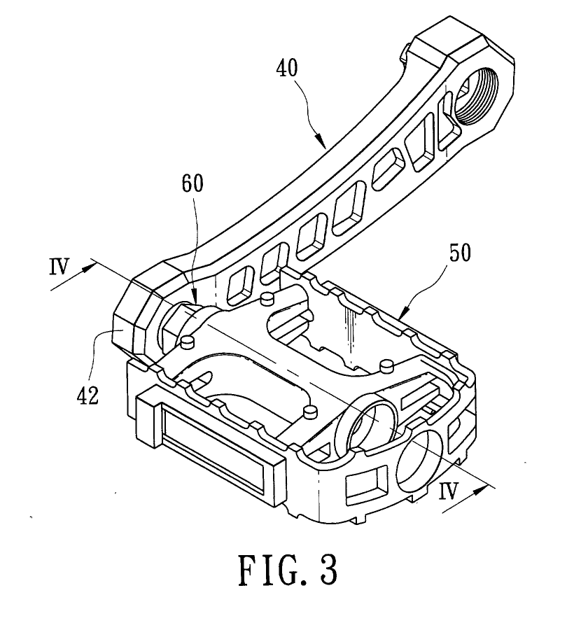

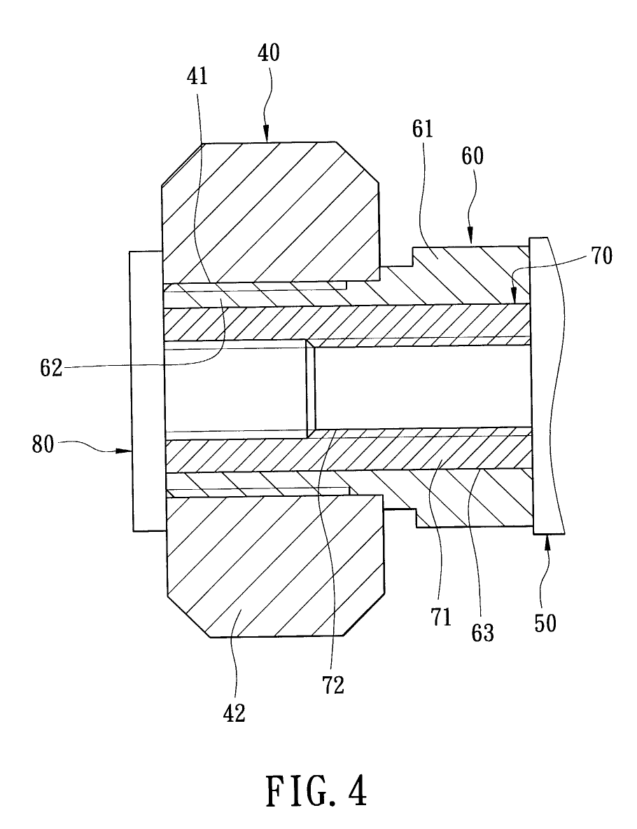

Referring to FIGS. 2 to 4, the preferred embodiment of a bicycle crank set according to the present invention is adapted to be mounted on a crank axle of a chain sprocket (not shown), and is shown to include a crank arm 40, a tubular adapter 60, a pedal unit 50, and a headed bolt 80.

As illustrated, the crank arm 40 extends in a longitudinal direction, and has two opposite sides and a pedal-connecting end 42 that is formed with an internally threaded hole 41 extending in a transverse direction relative to the longitudinal direction.

The tubular adapter 60 extends in the transverse direction, and has an externally threaded portion 62 inserted threadedly into the internally threaded hole 41 in the pedal-connecting end 42 of the crank arm 40, and an enlarged head 61 extending axially from the externally threaded portion 62. The adapter 60 confines a shaft hole 63 extending through the externally threaded portion 62 and the enlarged head 61.

The pedal unit 50 is disposed at one of the opposite sides of the crank arm 40, and includes a pedal shaft 70 and a pedal body 51 pivoted to the pedal shaft 70 so as to permit rotation of the pedal body 51 about the pedal shaft 70. The pedal shaft 70 has a crank-connecting end 71 that projects outwardly from the pedal body 51 into the shaft hole 63 in the adapter 60 and that is formed with an internally threaded hole 72.

The headed bolt 80 is disposed at the other of the opposite sides of the crank arm 40, extends into the shaft hole 63 in the tubular adapter 60, and threadedly engages the internally threaded hole 72 in the crank-connecting end 71 of the pedal shaft 70 so as to prevent disengagement of the pedal unit 50 from the crank arm 40.

Preferably, the enlarged head 61 of the tubular adapter 60 is polygonal in cross-section to facilitate turning of the tubular adapter 60 relative to the crank arm 40.

With the use of the tubular adapter 60, the direction of the thread formed on the externally threaded portion 62, the direction of the thread in the internally threaded hole 41, the direction of the thread formed in the internally threaded hole 72, and the direction of the thread formed on the headed bolt 80 are not required to be restricted in the clockwise or counterclockwise directions, thereby eliminating aforesaid disadvantage of the prior art.

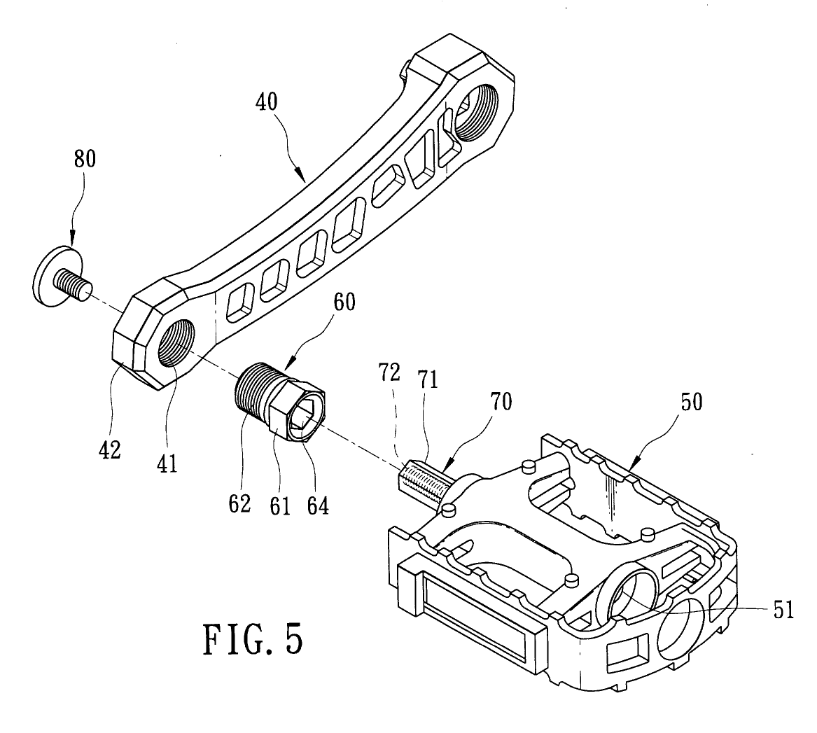

Referring to FIG. 5, a modified preferred embodiment of a bicycle crank set according to the present invention is shown to be similar to the previous embodiment in construction. The main difference resides in that the shaft hole 64 in the tubular adapter 60 has a polygonal cross-section. The crank-connecting end 71 of the pedal shaft 70 thus has a polygonal cross-section that complements the shaft hole 64 in the tubular adapter 60.

With this invention thus explained, it is apparent that numerous modifications and variations can be made without departing from the scope and spirit of this invention. It is therefore intended that the invention be limited only as indicated in the appended claims.

I claim:

1. A crank set comprising:
a crank arm extending in a longitudinal direction, and having two opposite sides and a pedal-connecting end that is formed with an internally threaded hole extending in a transverse direction relative to said longitudinal direction;
a tubular adapter extending in said transverse direction, and having an externally threaded portion inserted threadedly into said internally threaded hole in said pedal-connecting end of said crank arm, and an enlarged head extending axially from said externally threaded portion, said adapter confining a shaft hole extending through said externally threaded portion and said enlarged head;
a pedal unit disposed at one of said opposite sides of said crank arm, and including a pedal shaft and a pedal body pivoted to said pedal shaft so as to permit rotation of said pedal body about said pedal shaft, said pedal shaft having a crank-connecting end that projects outwardly from said pedal body into said shaft hole in said adapter and that is formed with an internally threaded hole; and
a headed bolt disposed at the other said opposite sides of said crank arm, extending into said shaft hole in said tubular adapter, and threadedly engaging said internally threaded hole in said crank-connecting end of said pedal shaft so as to prevent disengagement of said pedal unit from said crank arm.

2. The bicycle crank set as defined in claim 1, wherein said shaft hole in said tubular adapter has a polygonal cross-section, said crank-connecting end of said pedal shaft having a polygonal cross-section that complements said shaft hole in said tubular adapter.
